(19) United States
(12) Patent Application Publication
(10) Pub. No.: US 2014/0108209 A1
(43) Pub. Date: Apr. 17, 2014

(54) AGGREGATE MERCHANT MONITORING

(71) Applicant: MASTERCARD INTERNATIONAL, INC., Purchase, NY (US)

(72) Inventor: Walter F. Lo Faro, Chesterfield, MO (US)

(73) Assignee: MASTERCARD INTERNATIONAL, INC., Purchase, NY (US)

(21) Appl. No.: 13/652,909

(22) Filed: Oct. 16, 2012

(51) Int. Cl. G06Q 40/00

(52) U.S. Cl. 705/30

(57) ABSTRACT

A method of monitoring cashless transaction data includes extracting transaction history data for a merchant within a first predetermined time period from a transaction data storage. A plurality of forecast models that forecast transaction patterns for the merchant over the first predetermined time period are provided, each forecast model of the first plurality having a different forecast period. The forecast models may be constructed according to a Holt-Winters time-series forecast. The forecast model which most accurately forecasts periodic fluctuations in the transaction history data is selected, and a first forecast of transactions for the merchant for a first forecast period outside the first predetermined time period is provided. A score comparing the forecast with actual data for the first forecast period is further provided. An alert is generated when the score exceeds a predetermined threshold. Also disclosed are a computer and recording medium to carry out the method.

### BACKGROUND

1. Field of the Disclosure

The present disclosure relates to electronic transaction processing. More specifically, the present disclosure is directed to method and system for monitoring the transactional volume of aggregate merchants in order to detect data anomalies.

2. Brief Discussion of Related Art

The use of payment devices for a broad spectrum of cashless transactions has become ubiquitous in the current economy, accounting for hundreds of billions of dollars in transactions. The process and parties involved can be visualized for example as presented in FIG. 1, and can be thought of as a cycle, as indicated by arrow 10. A cardholder 12 may present a payment device 14, for example a payment card, transponder device, NFC-enabled smart phone, among others and without limitation, to a merchant 16 as payment for goods and/or services. The payment device 14 here is emblematic of any transaction device, real or virtual, by which the cardholder and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction thought a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a cardholder 12, despite not having a merchant account with an acquirer 20.

The acquirer 20 routes the transaction request to the network operator 22. The data included in the transaction request will identify the source of funds for the transaction. With this information, the network operator routes the transaction to the issuer 24. An issuer 24 is a party or entity, typically a bank, which is authorized by the network operator 22 to issue payment devices 14 on behalf of its customers (e.g., cardholder 12) for use in transactions to be completed on the network. The issuer 24 also provides the funding of the transaction to the network provider 22 for transactions that it approves in the process described.

The issuer 24 decision to authorize or decline the transaction is routed through the network operator 22 and acquirer 20, ultimately to the merchant 16 at the point of sale. This entire process is typically carried out by electronic communication, and under routine circumstances (i.e., valid card, adequate funds, etc.) can be completed in a matter of seconds. It permits the merchant 16 to engage in transactions with a cardholder 12, and the cardholder 12 to partake of the benefits of cashless payment, while the merchant 16 can be assured that payment is secured. This is enabled without the need for a preexisting one-to-one relationship between the merchant 16 and every cardholder 12 with whom they may engage in a transaction.

The issuer 24 may then look to its customer, e.g., cardholder 12 or other party having financial ownership or responsibility for the account(s) funding the payment device, for payment on approved transactions, for example through an existing line of credit where the payment device 14 is a credit card, or from funds on deposit where the payment device 14 is a debit card. Generally, a statement document 26 providing information on the cardholder's account is issued in this regard.

The network operator 20 can further build and maintains a data warehouse which stores and augments transaction data, for use in marketing, macroeconomic reporting, etc. To this end, transaction data from multiple transactions is aggregated for reporting purposes according to a location of the merchant 16. Additionally, one merchant 16 may operate plural card acceptance locations. Consider, for example, a chain or franchise having multiple business locations. These merchant locations are beneficially aggregated and assigned an aggregate merchant identifier for reporting purposes.

Of the actors in the transaction process, the merchant's data tends to be the least stable and most difficult to deal with. One of the challenges with merchant data is the fact that there is no universal merchant identifier. Rather, the network operator 22 must build and maintain the data warehouse on its own, derived from merchant data included in the transaction data delivered via the acquirer 20. Similarly, there is no reliable identifier on the data received that indicates if a merchant location belongs to a chain or not, for example for aggregation purposes. Again, the network operator 22 augments transactions with this information, based on the merchant name received, the acquiring bank, and several other fields. The process of grouping merchant locations into sets of chain merchants is called “merchant aggregation” and maintaining the integrity of these aggregations is a challenge.

If the merchants 16 and acquirers 20 never changed the way in which they submit their data, there would be no need for a monitoring system; but of course they do. Merchants 16 can change acquirers 20; they open and close locations; they rebrand themselves—just to name a few of the challenges. When any of these or other changes to merchant data happen, the rules used to assign an identifier to a merchant location and/or associate that merchant location with an aggregate merchant id often fail. Even cursory human oversight of each and every merchant location would be prohibitively expensive considering the total number of merchants 16 accepting authorized payment devices 14, or even that subset of aggregate merchants whom the network operator 22 wishes to monitor.

A solution to this aggregate merchant data quality deficit problem remains wanting.

### SUMMARY

MasterCard International, the assignee of the instant application, in its capacity as network operator 22 in the above-described process, has developed a solution to the problem of aggregate merchant data quality deficit. An automated system monitors transaction data. The system will alert a merchant analyst to investigate particular merchants when their data becomes suspect, making vastly more efficiency use of the merchant analyst's time. Dubbed the Merchant Monitoring System (MMS), there are distinct monitoring techniques. What follows herein is a description of these techniques.

Provided according to the present disclosure are a method of monitoring cashless transaction data. The method includes extracting transaction history data for a merchant within a first predetermined time period from a transaction data storage. A first plurality of forecast models that forecast transaction patterns for the merchant over the first predetermined time period are provided, each forecast model of the first plurality having a different forecast period. In some more particular embodiments, the forecast models may be constructed according to a Holt-Winters time-series forecast for each forecast period. The forecast model which most accurately forecasts periodic fluctuations in the transaction history data is selected.

Using the selected forecast model, a first forecast of transactions for the merchant for a first forecast period outside the first predetermined time period is provided. A score comparing the provided forecast with actual transaction data from the merchant for the first forecast period is further provided. An alert is generated in response to the score exceeding a predetermined first threshold. In some more particular embodiments, the score is a standard score, scaled to a calculated standard deviation of the transaction history data.

The method can further include extracting transaction history data for a merchant within a second predetermined time period from the transaction data storage, and providing a second plurality of forecast models that forecast transaction patterns for the merchant over the second predetermined time period. Here again, each forecast model of the first plurality has a different forecast period. In these embodiments, selecting the forecast model comprises selecting from the first plurality of forecast models and the second plurality of forecast models.

In certain embodiments, selecting the forecast model which most accurately forecasts periodic fluctuations in the transaction history data comprises selecting the forecast model having a greatest coefficient of determination with respect to the transaction history data.

To account for certain foreseeable exception criteria, the score value may be forced to an arbitrary value greater than the first threshold responsive to the existence of such predetermines exception criteria.

In further embodiments of the present disclosure, a second forecast of transactions for the merchant in a second forecast period is provided using the selected forecast model. Further, an extended forecast models of transaction patterns for the merchant in the second forecast period, reflecting the actual transaction data from the first forecast period, is used to provide a third forecast of transactions for the merchant for the second forecast period. The second an third forecasts are compared with one another, and an alert is generated in response to the second and third forecasts for the second forecast period differing by more than a predetermined second threshold.

Also disclosed herein is a computer operative to carry out a described method. Also disclosed herein is a machine-readable storage medium having a program of instruction thereon. That program of instruction, when executed by a computer, will cause the computer to carry out a described method.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a typical cycle for cashless transaction processing;

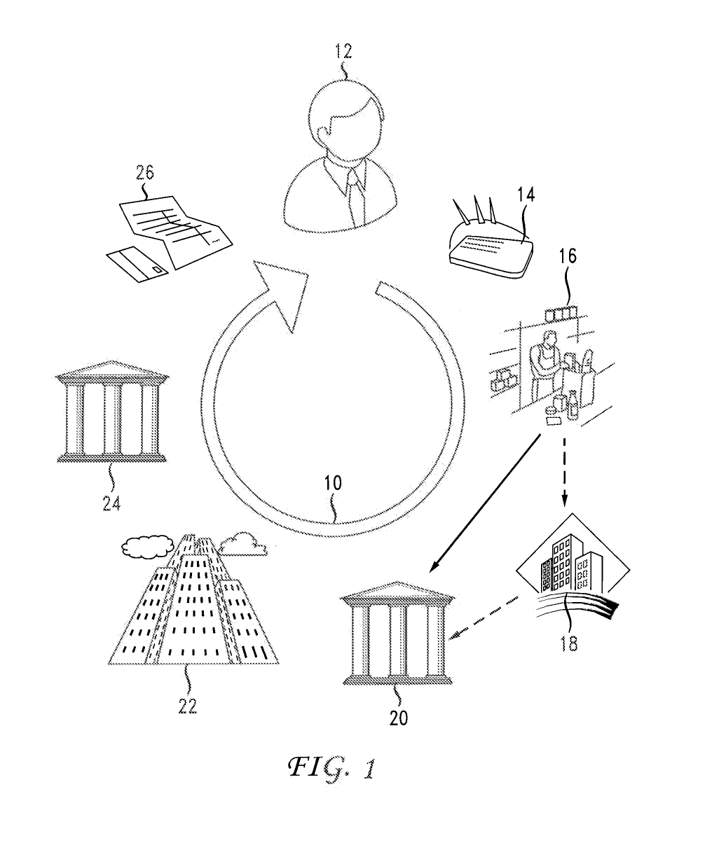

FIG. 2 illustrates a flowchart for revenue forecast and forecast scoring according to an exemplary embodiment of the present disclosure; and

FIG. 3 illustrates schematically a representative computer according to the present disclosure, operative to implement the disclosed methods.

### DETAILED DESCRIPTION

The Merchant Monitoring System (MMS) entails a two-step process of model building, and model scoring or validation. Many merchants have very predictable seasonal patterns to their transaction volume and simple forecasting takes advantage of this. Further, models predicting volume at each aggregate merchant are constructed, and when a period's actual volume becomes available the prediction and the actual are compared. If they differ significantly an analyst is alerted to investigate, in order to determine if there has been a data change resulting in misaggregation.

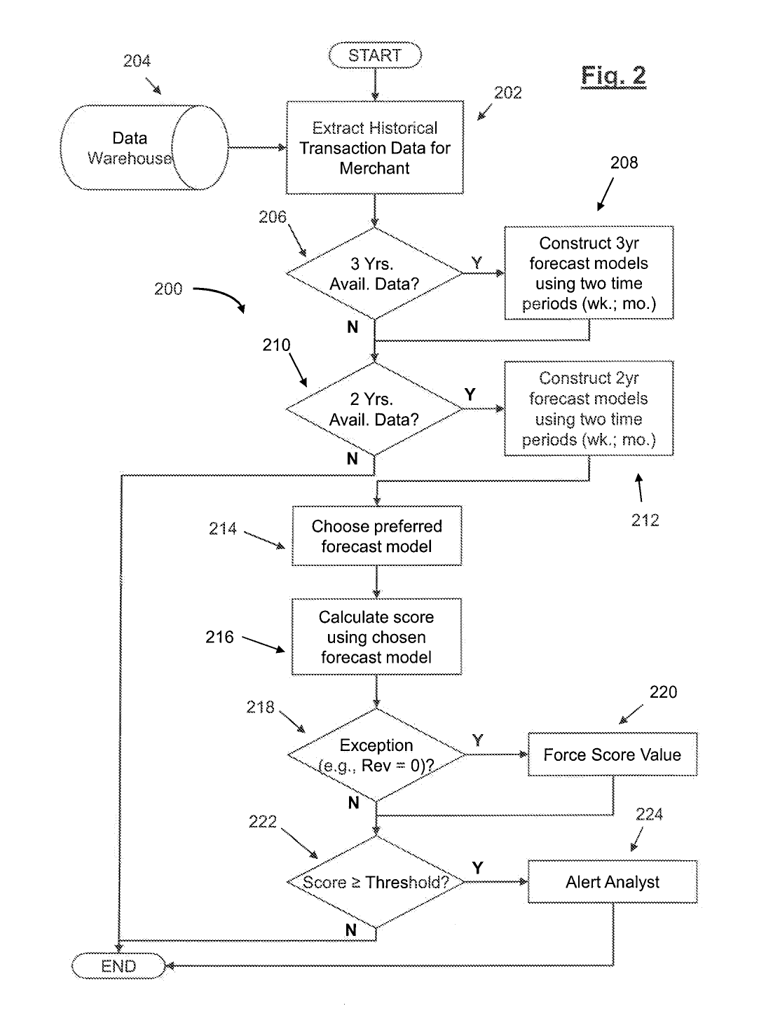

Referring now to FIG. 2, illustrated is a flowchart for a revenue forecast and forecast scoring process, generally 200. For each merchant location being monitored, a representative sample, e.g., two- or three-years', of historical transaction data are extracted 202 from a data warehouse 204. In some cases, plural models can be constructed, using different lengths of data history. These plural models can be compared to one another, to determine if there is agreement between the models, or for evidence of changing seasonal patterns between the timeframes of the respective models. Additionally, not all merchants will have a length of historical transaction data that is adequate to meet this threshold. For those merchants who have an adequate length of history to meet the shortest sample threshold, only those models will be constructed, and comparisons between models will be limited. Some merchants may not have sufficient data to meet even the shortest sample period. For those merchants, no models will be constructed, as any model constructed from inadequate data samples will be suspect in its accuracy (See, FIG. 2, ref. 210).

In order to construct the respective models, the total dollars spent by cashless transaction for each merchant in each subdivision of time during the sample period under investigation is computed. Typical time periods are quarterly, monthly, and weekly, with monthly and weekly forecasts being the exemplary, though not exclusive, focus of the present description. Forecasts may be constructed for biweekly, semi-monthly, or even other arbitrary regular or irregular periods. The time period subdivision of the forecasts may, but need not, be uniform over the range of the forecast. For example, merchants whose business and transaction patterns exhibit significant seasonality might merit more granular forecasts during the height of their seasons (e.g., weekly), while more general forecasts would be adequate during these merchants' off-season periods (e.g., monthly or semi-monthly).

Referring again to FIG. 2, in an exemplary embodiment of the present disclosure, and where data permits, plural models are constructed for each merchant, based upon different lengths of data history. Furthermore, within each respective historical data set, the models may be constructed for different forecast periods, e.g., weekly forecast and monthly forecast. For example, if three-years' data is available 206, models may be based upon that three-years' data. Further, plural models may be constructed 208 based upon that three-years data, using respectively different time periods of forecast, e.g., weekly and monthly. If only some shorter period of data is available 210, for example two-years', plural models may be constructed 212 based upon that two-years' data, using respectively different time periods of forecast, e.g., weekly and monthly.

Where two or more models are constructed, one of the forecast models must be selected 214 to calculate the forecast and score against actual results. The forecast models they may be compared for predictive accuracy, one measure of which is the coefficient of determination (“R²”, or “R-square” value). Other measures of correlation between the respective models and the underlying data may be considered as well. Generally, where plural models are available, the model having greater fidelity to the data, or a greatest R-squared value, is selected.

Each model constructed is a time-series forecast. One method known in the art for constructing a time-series forecast is the Holt-Winters forecast technique. The forecast model can be represented by the equation

forecast=(b+m*lead)*(seasonality factor)ₙ

In this equation, lead is a number of time periods into the future to be forecast. The value of lead will generally be 1 for monthly forecasts, and will be an integer between 1 and 5 for weekly forecasts.

Having constructed one or more predictive models, the forecasts produced by these models can be compared to actual data as it becomes available 216. One method of this comparison is to compute a standard score of “Z-score” of the forecast according to the following equation

$$score = \frac{( actual - forecast )}{σ}$$

Here, σ is the standard deviation for the time series data upon which the forecast model was built. The value of σ for each model is computed during the model-building process and used, inter alia, for this comparison. Where the Z-score value exceeds a predetermined threshold 222, as example only 3.5, an alert will be issued 224 to a merchant analyst to being further investigation into the nature of the deviation. The optimal value for this threshold will be subject to discovery by experimentation in practice, and subject to change periodically. The criteria for such optimization include the threshold being low enough to discover the maximum possible number of deviations, within a constraint of not exceeding a tolerable number of false positive alerts.

Alerts may also be issue based upon other exception criteria 218. Among them, if a merchant location has actual volume of zero dollars for any time period, an alert will be issued. In one form, the Z-score is forced 220 to some value above the threshold measure at 222 in order to generate an alert at 224. For example, a value of 100 or some other arbitrary number may be chosen. The forced score value is preferably selected from outside a predictable range of calculated or even likely anomalous Z-scores, regardless of the actual Z-score calculation. In this way, the alert can both call attention to the particular merchant location by nature of the forced score exceeding the threshold, and also communicate something about the nature of the alert to the merchant analyst (i.e., “a code 100”). Different forced codes may be used where more than one exception criteria exists, corresponding to the respective exception.

According to the foregoing described methods, an automated alert is generated 224 when the transaction dollar volume of a particular merchant deviates from a predictable trend by more than a specified threshold. The alert brings that merchant to the attention of an analyst for further investigation. While this Merchant Monitoring System represents a considerable advance, it nonetheless has certain identifiable weakness, which once identified, can be ameliorated.

For example, where a merchant's transaction volume changes coincide or nearly coincide with the end of the reporting period, e.g., a given month, the magnum of change may not be sufficient to outweigh the preceding portion of the reporting period in which transaction volume was normal. Accordingly, the overall deviation from the forecast is insufficient to exceed the reporting threshold at 222, and thus to generate an alert at 224. Therefore, what was in fact a reporting period in which an anomalous change in transaction data occurred, may be considered normal and within acceptable fluctuation and would remain undetected.

In such a case, the problem can be further compounded, in that the data from the undetected anomalous reporting period would then be used in generating the next period's model. In other words, what was in fact an anomalous period would not be detected as such, and would be considered normal. Further reliance on that anomalous period as a normal period would alter the model going forward, further impairing if not impeding the ability of the forecast to detect continuing and future anomalies.

In order to address this problem, one solution is to use a shorter reporting period for modeling. However, this generates multiple times greater computational overhead for a similar forecast range. Also, there is no assurance that the data provides any discernable temporal pattern at the shorter interval, as compared to an equal subdivision of the longer interval. In other words, there may be no particular insight into the transactional pattern to be gained at the expense of shortening the forecast interval. Nor can there be assurance that the more frequent model itself more accurately reflects seasonal, periodic, or other temporal fluctuations in transaction data. Predictive accuracy may be compromised by arbitrarily selecting the shorter forecast reporting period.

Another solution which can be employed without decreasing the length of the forecast period or increasing the frequency of model generation is to use a particular iteration of the forecast model to project out more than one period into the future. For example, one would use a monthly forecast model prepared in June to forecast transaction volume both in July and in August. Then, when an updated or extended forecast model is prepared based upon actual merchant transaction data generated during July, the August forecast using the June model and the August forecast using the July model can be compared with one another. Deviation in forecasts for a given month between two models by more than a predetermined threshold can be used to generate an alert to signal for the attention of a merchant analyst. In some embodiments, the successive forecast periods may overlap, for example rolling quarterly forecasts generated each month, or rolling monthly forecasts refreshed weekly. The successive forecast periods need not be mutually exclusive, nor even adjacent.

Another problem arises where a particular aggregate merchant's transaction volume is derived in large part from periodic and recurring payments. Examples of such merchants are gyms, cell phone providers, subscription publishers (print or web), among many others. Standard forecasting is often ineffective for these merchants at smaller forecast periods, e.g., at the weekly level. Some weeks have little to no transaction volume at all, while others have the bulk of all transaction volume, and further there is no discernable pattern. In order to compensate for this disruptive transaction pattern, we first consider all of the recurring payment customers for one such merchant in month n. Then, in month n+1, the dominant merchant source for their recurring payments should be the same.

Therefore, for each recurring payment aggregate merchant, the set of all transaction devices 14 with a recurring payment transaction there within the previous month, or other reporting period, is determined. All recurring payment transactions from the previous period are gathered for each of these customer sets. Within these transaction sets, the recurring payment merchant with the highest spend is determined, called the dominant merchant for that set. If the dominant merchant in a card set differs from the merchant whose customers define the set, an alert is issued to call for further investigation by a merchant analyst.

It will be appreciated by those skilled in the art that the MMS as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

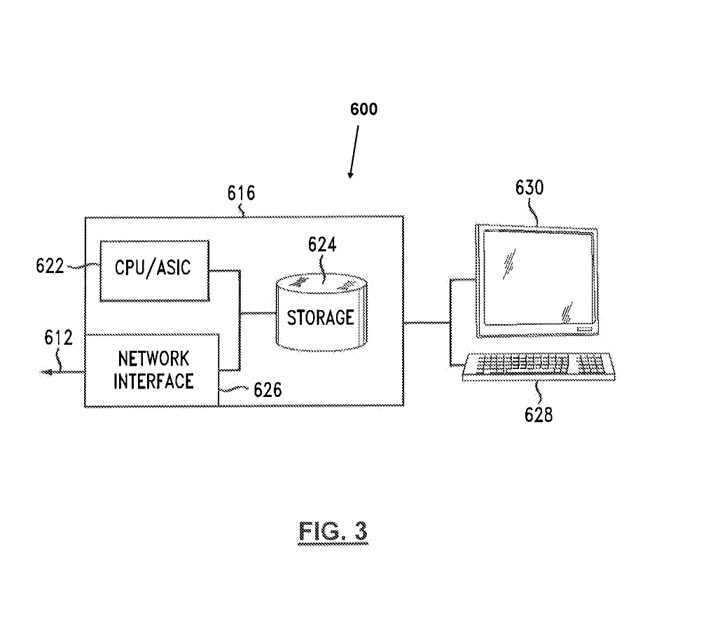

Turning then to FIG. 3, illustrated schematically is a representative computer 616 of the system 600. The computer 616 includes at least a processor or CPU 622 which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a GUI.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of monitoring cashless transaction data, the method comprising:
extracting transaction history data for a merchant within a first predetermined time period from a transaction data storage;
providing a first plurality of forecast models that forecast transaction patterns for the merchant over the first predetermined time period, each forecast model of the first plurality having a different forecast period;
selecting the forecast model which most accurately forecasts periodic fluctuations in the transaction history data;
using the selected forecast model, providing a first forecast of transactions for the merchant for a first forecast period outside the first predetermined time period;
providing a score comparing the provided forecast with actual transaction data from the merchant for the first forecast period; and
generating an alert in response to the score exceeds a predetermined first threshold.

2. The method according to claim 1, further comprising:
extracting transaction history data for a merchant within a second predetermined time period from the transaction data storage; and
providing a second plurality of forecast models that forecast transaction patterns for the merchant over the second predetermined time period, each forecast model of the first plurality having a different forecast period,
wherein selecting the forecast model which most accurately forecasts periodic fluctuations in the transaction history data comprises selecting from the first plurality of forecast models and the second plurality of forecast models.

3. The method according to claim 1, wherein providing a first plurality of forecast models comprises constructing a Holt-Winters time-series forecast for each forecast period.

4. The method according to claim 1, wherein selecting the forecast model which most accurately forecasts periodic fluctuations in the transaction history data comprises selecting the forecast model having a greatest coefficient of determination with respect to the transaction history data.

5. The method according to claim 1, wherein providing a score comparing the provided forecast with actual transaction data from the merchant for the first forecast period comprises providing a standard score scaled to a calculated standard deviation of the transaction history data.

6. The method according to claim 1, further comprising:
forcing the score value to an arbitrary value greater than the first threshold responsive to the existence of a predetermines exception criteria.

7. The method according to claim 1, further comprising:
using the selected forecast model, providing a second forecast of transactions for the merchant in a second forecast period;
using an extended forecast model of transaction patterns for the merchant in the second forecast period, the extended forecast model reflecting the actual transaction data from the first forecast period, providing a third forecast of transactions for the merchant for the second forecast period;
comparing the second and third forecasts; and
generating an alert in response to the second and third forecasts for the second forecast period differ by more than a predetermined second threshold.

8. A non-transitory machine-readable storage medium, having thereon a program of instruction which, when executed by processor, cause the processor to:
extract transaction history data for a merchant within a first predetermined time period from a transaction data storage;
provide a first plurality of forecast models that forecast transaction patterns for the merchant over the first predetermined time period, each forecast model of the first plurality having a different forecast period;
select the forecast model which most accurately forecasts periodic fluctuations in the transaction history data;
using the selected forecast model, provide a first forecast of transactions for the merchant for a first forecast period outside the first predetermined time period;
provide a score comparing the provided forecast with actual transaction data from the merchant for the first forecast period; and
generate an alert in response to the score exceeds a predetermined threshold.

9. The non-transitory machine-readable storage medium according to claim 8, wherein the program of instructions further causes the processor to:
extract transaction history data for a merchant within a second predetermined time period from the transaction data storage; and
provide a second plurality of forecast models that forecast transaction patterns for the merchant over the second predetermined time period, each forecast model of the first plurality having a different forecast period,
wherein the forecast model which most accurately forecasts periodic fluctuations in the transaction history data is selected from the first plurality of forecast models and the second plurality of forecast models.

10. The non-transitory machine-readable storage medium according to claim 8, wherein providing a first plurality of forecast models comprises constructing a Holt-Winters time-series forecast for each forecast period.

11. The non-transitory machine-readable storage medium according to claim 8, wherein selecting the forecast model which most accurately forecasts periodic fluctuations in the transaction history data comprises selecting the forecast model having a greatest coefficient of determination with respect to the transaction history data.

12. The non-transitory machine-readable storage medium according to claim 8, wherein providing a score comparing the provided forecast with actual transaction data from the merchant for the first forecast period comprises providing a standard score scaled to a calculated standard deviation of the transaction history data.

13. The non-transitory machine-readable storage medium according to claim 8, wherein the program of instructions further causes the processor to:
force the score value to an arbitrary value greater than the threshold responsive to the existence of a predetermines exception criteria.

14. The non-transitory machine-readable storage medium according to claim 8, wherein the program of instructions further causes the processor to:
use the selected forecast model to provide a second forecast of transactions for the merchant in a second forecast period;
use an extended forecast model of transaction patterns for the merchant in the second forecast period, the extended forecast model reflecting the actual transaction data from the first forecast period, providing a third forecast of transactions for the merchant for the second forecast period;
compare the second and third forecasts; and
generate an alert in response to the second and third forecasts for the second forecast period differ by more than a predetermined threshold.

15. A system for monitoring cashless transaction data, the system comprising:
a computer including a processing device and a non-transitory, machine-readable storage medium, having thereon a program of instruction which, when executed by processor, cause the processor to:
extract transaction history data for a merchant within a first predetermined time period from a transaction data storage;
provide a first plurality of forecast models that forecast transaction patterns for the merchant over the first predetermined time period, each forecast model of the first plurality having a different forecast period;
select the forecast model which most accurately forecasts periodic fluctuations in the transaction history data;
using the selected forecast model, provide a first forecast of transactions for the merchant for a first forecast period outside the first predetermined time period;
provide a score comparing the provided forecast with actual transaction data from the merchant for the first forecast period; and
generate an alert in response to the score exceeds a predetermined threshold.

16. The system according to claim 15, wherein the program of instructions further causes the processor to:
extract transaction history data for a merchant within a second predetermined time period from the transaction data storage; and
provide a second plurality of forecast models that forecast transaction patterns for the merchant over the second predetermined time period, each forecast model of the first plurality having a different forecast period,
wherein the forecast model which most accurately forecasts periodic fluctuations in the transaction history data is selected from the first plurality of forecast models and the second plurality of forecast models.

17. The system according to claim 15, wherein providing a first plurality of forecast models comprises constructing a Holt-Winters time-series forecast for each forecast period.

18. The system according to claim 15, wherein selecting the forecast model which most accurately forecasts periodic fluctuations in the transaction history data comprises selecting the forecast model having a greatest coefficient of determination with respect to the transaction history data.

19. The system according to claim 15, wherein providing a score comparing the provided forecast with actual transaction data from the merchant for the first forecast period comprises providing a standard score scaled to a calculated standard deviation of the transaction history data.

20. The system according to claim 15, wherein the program of instructions further causes the processor to:
force the score value to an arbitrary value greater than the threshold responsive to the existence of a predetermines exception criteria.

21. The system according to claim 15, wherein the program of instructions further causes the processor to:
use the selected forecast model to provide a second forecast of transactions for the merchant in a second forecast period;
use an extended forecast model of transaction patterns for the merchant in the second forecast period, the extended forecast model reflecting the actual transaction data from the first forecast period, to provide a third forecast of transactions for the merchant for the second forecast period;
compare the second and third forecasts; and
generate an alert in response to the second and third forecasts for the second forecast period differ by more than a predetermined threshold.

22. A method of monitoring cashless transaction data, the method comprising:
extracting transaction history data for a first merchant within a first predetermined time period from a transaction data storage;
identifying a first plurality of customers which exhibit a pattern of recurring transactions with the first merchant;
examining transactions engaged in by the each of first plurality of customers subsequent to the first predetermined time period;
identifying, among the examined transactions, whether there exists a common second merchant with which each of a predetermined portion of the first plurality of customers engaged in at least one recurring transaction with; and
responsive to the existence of the common second merchant, generating an alert indicating a correlation between the first merchant and the second merchant.

23. The method according to claim 22, wherein the first merchant is part of an aggregate merchant, the method further comprising including the second merchant in the aggregate merchant comprising the first merchant.

24. A non-transitory machine-readable storage medium, having thereon a program of instruction which, when executed by processor, cause the processor to extract transaction history data for a first merchant within a first predetermined time period from a transaction data storage;
identify a first plurality of customers which exhibit a pattern of recurring transactions with the first merchant;
examine transactions engaged in by the each of first plurality of customers subsequent to the first predetermined time period;
identify, among the examined transactions, whether there exists a common second merchant with which each of a predetermined portion of the first plurality of customers engaged in at least one recurring transaction with; and
responsive to the existence of the common second merchant, generate an alert indicating a correlation between the first merchant and the second merchant.

25. The non-transitory machine-readable storage medium according to claim 24, wherein the first merchant is part of an aggregate merchant, the program of instruction further causing the processor to include the second merchant in the aggregate merchant comprising the first merchant.
